(19) United States
(12) Patent Application Publication
(10) Pub. No.: US 2012/0225174 A1
(43) Pub. Date: Sep. 6, 2012

(54) SYSTEM AND METHOD FOR PREPARING SKEWERED FOOD PRODUCTS

(76) Inventor: John DeAlto, Brick, NJ (US)

(21) Appl. No.: 13/410,706

(22) Filed: Mar. 2, 2012

Related U.S. Application Data
(60) Provisional application No. 61/448,549, filed on Mar. 2, 2011.

(51) Int. Cl. A47J 37/04; A47J 43/28; A23P 1/00

(52) U.S. Cl. 426/421; 99/419

(57) ABSTRACT

Embodiments of the present invention relate to an apparatus for facilitating the skewering of meats, vegetables, fish, fruits, and other food products in connection with the preparation of kabobs and the like. In one embodiment of the present invention, an apparatus for skewering food products comprising: a tray portion having at least two opposing sidewalls having skewer passageways extending therethrough, and a plurality of food sections provided therein, each food section defined by at least one length divider and at least one width divider, the width divider having a skewer passageway extending therethrough and aligning with the skewer passageways of the two opposing sidewalls; and a lid portion, rotatably connected to the tray portion, the lid portion comprising a substantially flat inner surface for covering the food sections of the tray portion in a closed position.

### CROSS-REFERENCE TO RELATED APPLICATIONS

The present application claims priority to U.S. Provisional Patent Application Ser. No. 61/448,549, entitled “System and Method for Preparing Skewered Food Products” filed Mar. 2, 2011, the disclosure of which is incorporated herein by reference in its entirety.

### BACKGROUND

1. Field of the Invention

Embodiments of the present invention are generally related to a system and method for preparing skewered food products. More specifically, embodiments of the present invention relate to an apparatus for facilitating the skewering of meats, vegetables, fish, fruits, and other food products in connection with the preparation of kabobs and the like.

2. Description of Related Art

Grilling food on skewers, particularly meat such as beef, chicken and pork, is native to numerous cultures around the world, including cultures in and around Asia, the Middle East, India and the Mediterranean. While common among these cultures, grilled meats on skewers are enjoyed around the world, and particularly in the United States.

These foods on skewers include, but are not limited to: shish kebabs or kebabs (i.e., grilled chunks of marinated beef, lamb, pork, chicken, seafood, vegetables or fruit on skewers); satay (i.e., grilled pieces of marinated pork, chicken, or beef on skewers); yakatori and other “-tories” (i.e., grilled chunks of chicken, seafood or beef on skewers) or the like.

In addition to commercial food establishments, food on skewers are prepared and grilled by consumers on indoor and outdoor grills on a regular basis. However, the preparation of meat and other foods on skewers is not a trivial task. Preparing meat on skewers can be labor-intensive, time-consuming, tricky, and potentially dangerous.

For example, chunks of meat, vegetables, or fruit are typically skewered by hand one chunk at a time, with one hand holding a chunk of meat while the other hand guides a sharp skewer through the approximate center of the chunk of food, or with one hand holding a skewer and the other hand guiding a chunk of food onto the sharp tip of the skewer. Each chunk of food is then slid down the skewer into its desired position. Guiding a sharp skewer through a chunk of food requires some degree of skill and concentration. Misplacement of the food onto a skewer may result in the food falling off the skewer during grilling and/or an unattractive appearance (e.g., the meat does not appear uniform on the skewer).

In addition, skewers are typically sharp sticks and can be potentially dangerous if improperly handled. The sharp tip of the skewer must be forced into and slid through a chunk of food, and if the proper skill and control is not applied, injuries may result such as cuts, puncture wounds and/or lacerations to the fingers or hands.

Thus, there is a need for a system and method for preparing skewered food products.

### SUMMARY

Embodiments of the present invention are generally related to a system and method for preparing skewered food products. More specifically, embodiments of the present invention relate to an apparatus for facilitating the skewering of meats, vegetables, fish, fruits, and other food products in connection with the preparation of kabobs and the like.

In one embodiment of the present invention, an apparatus for skewering food products comprising: a tray portion having at least two opposing sidewalls having skewer passageways extending therethrough, and a plurality of food sections provided therein, each food section defined by at least one length divider and at least one width divider, the width divider having a skewer passageway extending therethrough and aligning with the skewer passageways of the two opposing sidewalls; and a lid portion, rotatably connected to the tray portion, the lid portion comprising a substantially flat inner surface for covering the food sections of the tray portion in a closed position.

In another embodiment of the present invention, a system for skewering food products comprising: a skewering apparatus comprising: a tray portion comprising: at least two opposing sidewalls having skewer passageways extending therethrough; a plurality of food sections provided therein, each food section defined by at least one length divider and at least one width divider, the width divider having a skewer passageway extending therethrough and aligning with the skewer passageways of the two opposing sidewalls; and a latch portion on an outside surface thereof; and a lid portion, rotatably connected to the tray portion, the lid portion comprising: a substantially flat inner surface for covering the food sections of the tray portion in a closed position; and a locking mechanism on an outer surface of the lid portion for mating with a latch portion on an outside surface of the tray portion; and a plurality of skewers for fitting into the skewer passageways of the tray portion, and extending the entire length thereof.

In yet another embodiment of the present invention, a method of skewering food on a skewer comprising: providing a skewering apparatus comprising: tray portion comprising: at least two opposing sidewalls having skewer passageways extending therethrough; a plurality of food sections provided therein, each food section defined by at least one length divider and at least one width divider, the width divider having a skewer passageway extending therethrough and aligning with the skewer passageways of the two opposing sidewalls; and a latch portion on an outside surface thereof; and a lid portion, rotatably connected to the tray portion, the lid portion comprising: a substantially flat inner surface for covering the food sections of the tray portion in a closed position; and a locking mechanism on an outer surface of the lid portion for mating with a latch portion on an outside surface of the tray portion; providing a plurality of skewers; placing a food product in each of the plurality of food sections within the tray; closing the lid; inserting a skewer into each of the skewer passageways on one of the sidewalls of the tray portion; pushing the skewer through each of the skewer passageways of the width dividers aligning with the skewer passageways of the sidewall, passing through the food in the food portion defined by such width dividers, until a tip of the skewer exists the skewering apparatus via the skewer passageway on the opposing sidewall; opening the lid; and removing each of the skewers by lifting vertically thereon.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a top view of a system for preparing skewered food products in accordance with one embodiment of the present invention;

FIG. 2 depicts a side view of a system for preparing skewered food products in accordance with one embodiment of the present invention;

FIG. 3 depicts a top view of a system for preparing skewered food products in accordance with another embodiment of the present invention;

FIG. 4A depicts a front view of a divider tab in accordance with one embodiment of the present invention;

FIG. 4B depicts a top view of a tray for receiving a divider tab in accordance with one embodiment of the present invention;

FIG. 5 depicts a top view of a system for preparing skewered food products in accordance with yet another embodiment of the present invention; and

FIG. 6 depicts a side view of a system for preparing skewered food products in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a system and method for preparing skewered food products. More specifically, embodiments of the present invention relate to an apparatus for facilitating the skewering of meats, vegetables, fish, fruits, and other food products in connection with the preparation of kabobs and the like.

Although embodiments of the present invention are described as being dedicated to skewering food products, those of ordinary skill in the art may recognize equally suitable uses for embodiments of the present invention. As such, the systems and methods described herein should not be limited to the intended uses disclosed herein, but should be inclusive of alternative uses provided the novel features of embodiments of the present invention remain.

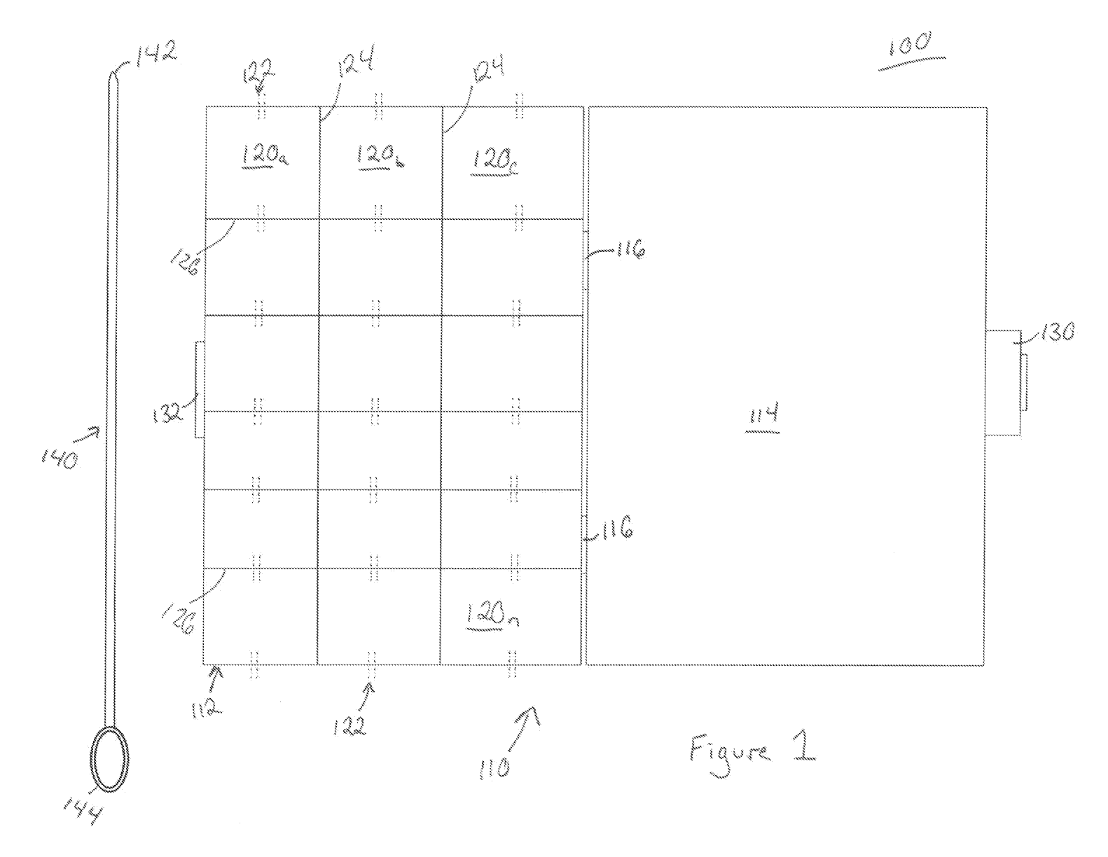

FIG. 1 depicts a top view of a system for preparing skewered food products in accordance with one embodiment of the present invention. The system 100 for preparing skewered food products generally comprises a skewering apparatus 110 having a tray 112 and a lid 114, as well as at least one skewer 140, often having a sharp end 142 and an optional handle 144. The skewer 140 may comprise any rigid instrument capable of piercing through food products and withstanding heat during a cooking process. The skewer 140 may be made of wood (e.g., bamboo), metal (e.g., stainless steel), ceramics, or other readily available suitable materials.

The skewering apparatus 110 may generally comprise any shape, size or material suitable for embodiments of the present invention. For example, in one embodiment, the skewering apparatus 110 may generally comprise a polymer, metal, wood, glass, ceramics, or combinations thereof. Generally, the size of the skewering apparatus 110 may be limited in length to the length of a standard commercial skewer device, e.g., from about 8 to about 24 inches in length. However, nothing in this disclosure should be deemed limiting with regard to size, shape or material for embodiments of the present invention.

The lid 114 of the skewering apparatus 110 is generally connected to the tray 112 by at least one hinge 116, for example, a living hinge, although a removable and separable lid is also contemplated. In many embodiments, the lid 114 comprises a substantially rigid structure, designed to fit over the open surface of the tray 112, and, in certain embodiments, may be temporarily sealed by a locking mechanism 130 mated with a latch 132 (e.g., similar to a lunch box or tackle box). In many embodiments, the lid 114 is generally flat; however, in some embodiments, the lid 114 may comprise a reasonable depth (i.e., it may have a lip) for fitting around a top section of the sidewalls making up the tray 112. In one embodiment, the lid 114 may have a depth substantially equal to or slightly less than the depth of the tray 112, as described herein. Optionally, in certain embodiments the top surface of the lid may comprise a handle (not shown) for ease of transport.

In many embodiments the flat inner surface of the lid may be important in order to assist in compression food that may be within the skewering apparatus, to facilitate the passing of a skewer therethrough. In certain instances, where food is left uncompressed, it may be difficult for the skewer to pass through the center thereof, as there may be room for the food to move or deform when the skewer hits it.

The tray 112 generally comprises a plurality of food sections 120a-n (collectively or generally referenced herein as food sections 120), where n comprises any number of food sections suitable for embodiments of the present invention. Each of the food sections 120 may be defined by a bottom surface of the tray, one or more sidewalls of the tray, or any of a length divider 124 or width divider 126. The variation in defining each food section 120 depends on the size of the skewering apparatus 110. Embodiments of the present invention provide the skewering apparatus 110 may comprise as few as one food section 120 (i.e., the food section is solely defined by the side walls and bottom surface of the tray), and as many food sections 120 (i.e., as many length dividers 124 and/or width dividers 126) as can reasonably be provided with the tray 112 without departing from the nature and scope of embodiments of the present invention.

In some embodiments of the present invention, the tray 112 comprises between about one length divider 124 to about eleven length dividers 124, and between about one width divider 126 to about eleven width dividers 126. In one embodiment of the present invention, the tray 112 comprises three length dividers 124 and five width dividers 126, creating a tray having a 4×6 food sections layout, and 24 total food sections. Alternative embodiments of the present invention appreciate that any number or combinations of layouts may be suitable and within the scope of embodiments of the present invention.

In accordance with one embodiment, as shown, a skewer passageway 122 may be provided through each of the width dividers 126, through each of the food sections 120. As shown in the Figure, the skewer passageway 122 may generally allow for a skewer 140 to pass entirely through the skewering apparatus 110 from one end to an opposing end, parallel to the length dividers 124. As such, in operation, where any type of food product may be provided in each of the food sections 120, a skewer 140 may enter a skewer passageway 122, and pass through each of the of the aligned food sections, skewering such food in the process. It should be appreciated, however, although the skewer passageways 122 are described as running parallel to the length dividers 124, alternative embodiments of the present invention may provide for the skewer passageways 122 to run parallel to the width dividers. As such, any reference to direction should not be deemed limiting, but rather present solely for exemplary purposes.

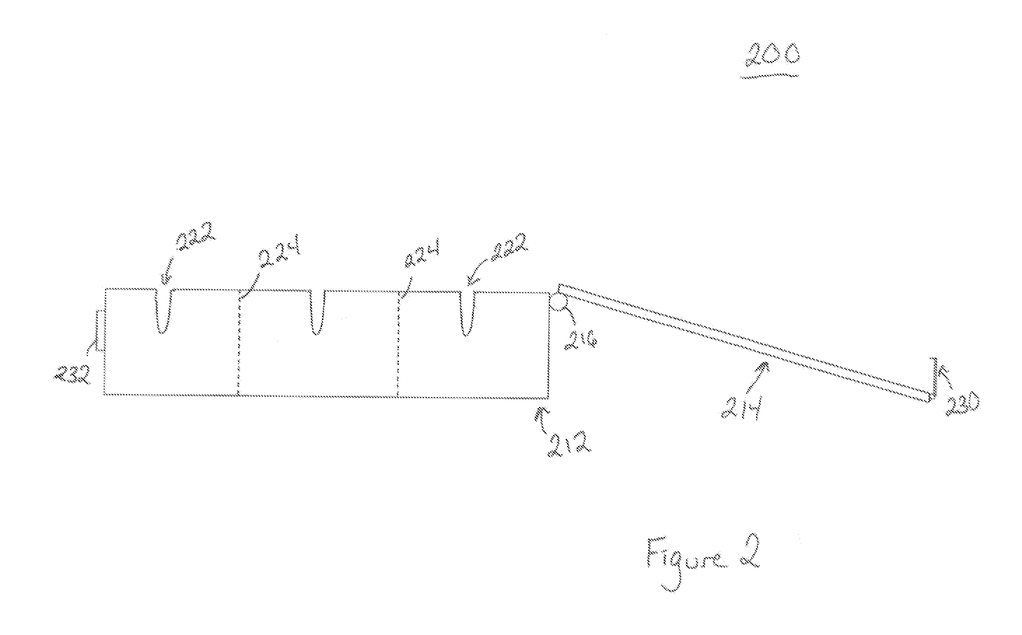

FIG. 2 depicts a side view of a system for preparing skewered food products in accordance with one embodiment of the present invention. The system 200 of FIG. 2 portrays how the skewering passageway 222 may be presented in the sidewall of the tray 212. In one embodiment of the present invention, the skewering passageway 222 comprises a slot or cut, open on a top edge of the tray, such that in operation, a skewer may be lifted out of the tray without physical impedance. In other embodiments of the present invention, however, the skewering passageway 222 may comprise a hole through the portion of the sidewall, and a movable or removable structure may be in place preventing the skewer from merely lifting vertically out of the tray.

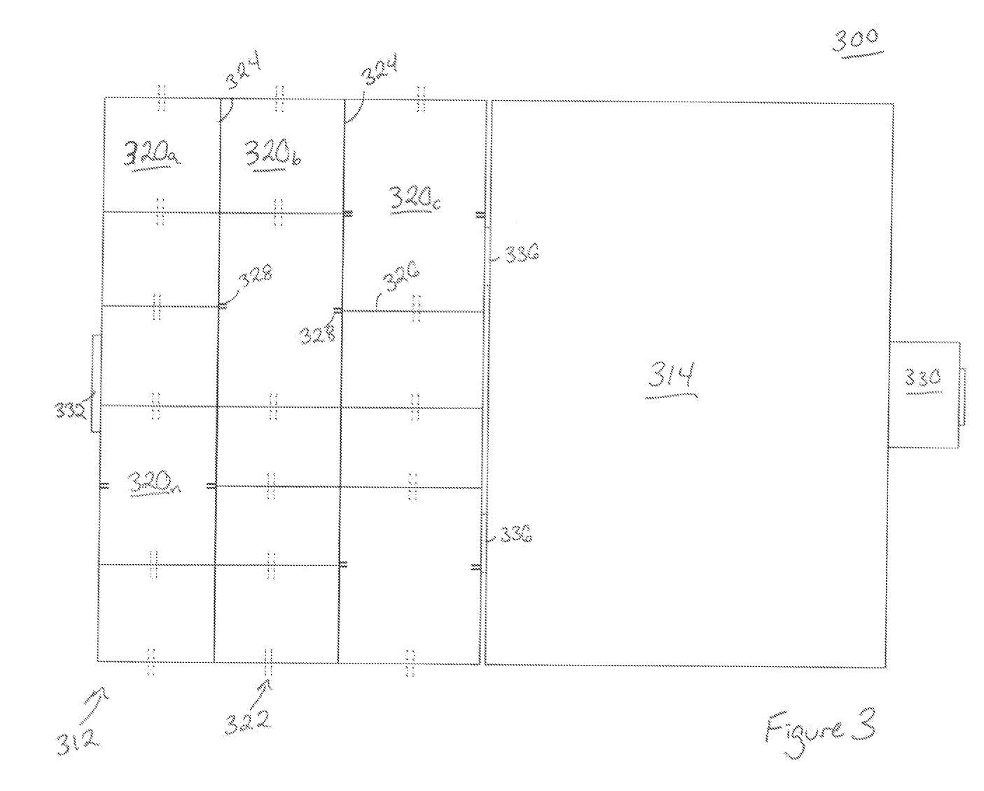

FIG. 3 depicts a top view of a system for preparing skewered food products in accordance with another embodiment of the present invention. The system 300 generally comprises a similar tray 312 and lid 314 structures as disclosed above. In the embodiment shown, however, the width dividers 326 and/or the length dividers 328 may be provided in the form of a divider tab. In such an embodiment, the divider tabs 326 may be movable, removable, etc., by sliding into a guide rail system 328. By allowing for such divider tabs, such embodiments may be able to allow for larger food products (e.g., larger pieces of meat, full size vegetables, etc.) to be skewered on the same skewer as a smaller piece of food fitting in a standard sized food section 320.

The guide rail system 328 may comprise any type of fitting structure for accompanying the divider tabs. For example, in one embodiment, the guide rail system 328 comprises pairs of opposing projections at each intersection between food sections 320. In such an embodiment, a divider tab could slide between such pairs of opposing projections, and be retained in place.

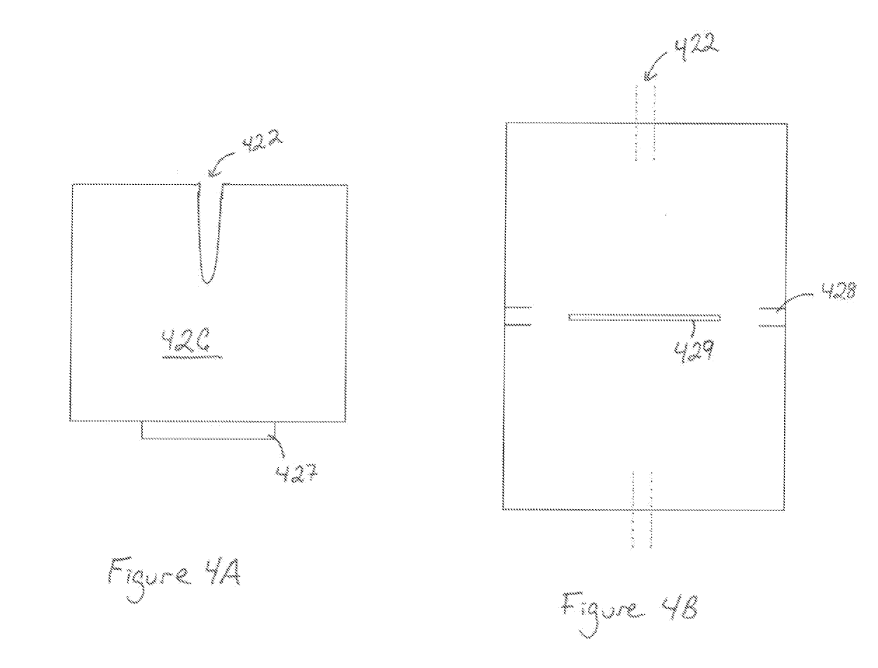

FIGS. 4A and 4B depict a front view of a divider tab in accordance with one embodiment of the present invention, and a top view of a tray for receiving a divider tab in accordance with one embodiment of the present invention, respectively. As shown in the Figures, the divider tab 426 may generally comprise a planar object having at least a skewering passageway 422 extending therethrough. Optionally, the divider tab 426 may also comprise a base projection 427 to assist with the positioning of the divider tab 426 in the tray. In the exemplary embodiment shown, the divider tab 426 may slide into the guide rail system 428 and may also allow for the base projection 427 to snap or lock into place into a base support 429.

Alternative embodiments of the present invention may comprise any number of additional features for moving and adjusting the divider tabs as described herein. All such known means for adapting one planar component firmly into a perpendicular planar device should be considered acceptable for embodiments of the present invention.

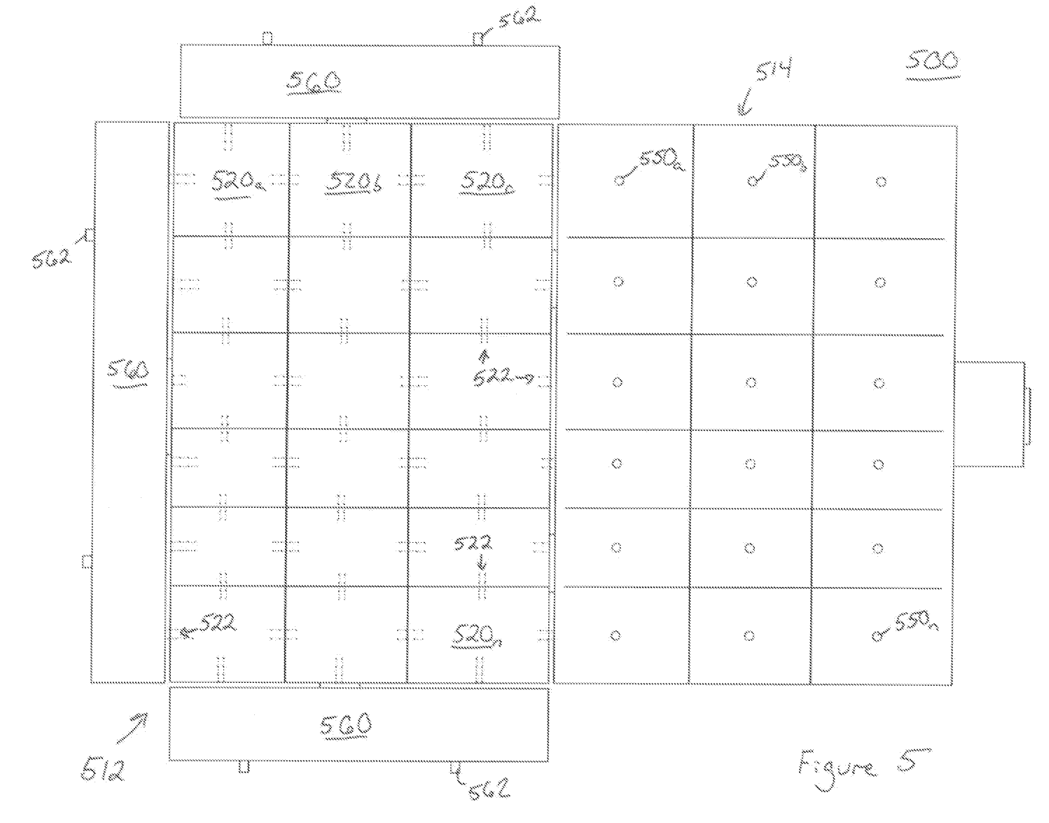

FIG. 5 depicts a top view of a system for preparing skewered food products in accordance with yet another embodiment of the present invention. The system 500 is substantially similar to the embodiments described above, with various optional features. In one embodiment of the present invention, the system 500 may allow for food products to further be marinated within the skewering apparatus, prior to or after skewering, but before cooking.

In such an embodiment, food products may be provided in each of the food sections 520, and the lid 514 closed over the top of the tray 512. Over each of the food sections 520a-n, a marinade portal 550a-n (collectively or generally referenced herein as marinade portal(s) 550) may be provided in the lid 514. The marinade portals 550 may generally comprise an aperture through the lid 514, sufficiently sized to allow a marinade to pass therethrough and substantially fill (if desired) one of the food sections 520. Whereas each food section 520 may be aligned with its own marinade portal 550, different types of marinades may be utilized for each of the food sections 520.

Optionally, to prevent marinade from exiting the skewering apparatus, one or more sealing panels 560 may be provided around the outer surface of the side walls of the tray 512. Such sealing panels 560 may be rotatably connected to the tray 512 via a hinge about the bottom surface of the tray, and may stay in a closed position with a mechanical closure device, for example, a clip 562. In the embodiment shown, where skewer passageways 522 extend in both a length and width direction, such sealing panels 560 may be provided around all four side walls of the tray 512 (note: a fourth sealing panel may be provided under the lid 514 in the view shown). In other embodiments, however, where the skewer passageways 522 extend only in one of the width or length direction, only two sealing panels 560 may be necessary. Instead of large sealing panels, any type of stopper, plug, gasket, flange, etc., may be utilized to effectively plug the skewer passageways and prevent spillage of any fluids contained therein.

In one alternative embodiment, where a user may desire to allow food products to marinade for a significant period of time (e.g., a day, a week, or longer), it may be desirable to further provide a sealing panel, plug, cover or the like, over the top surface of the lid 514, sealing off the marinade portals 550. As such, when all sealing panels (or similarly intended structures) are in place, the skewering apparatus is substantially sealed from outside elements.

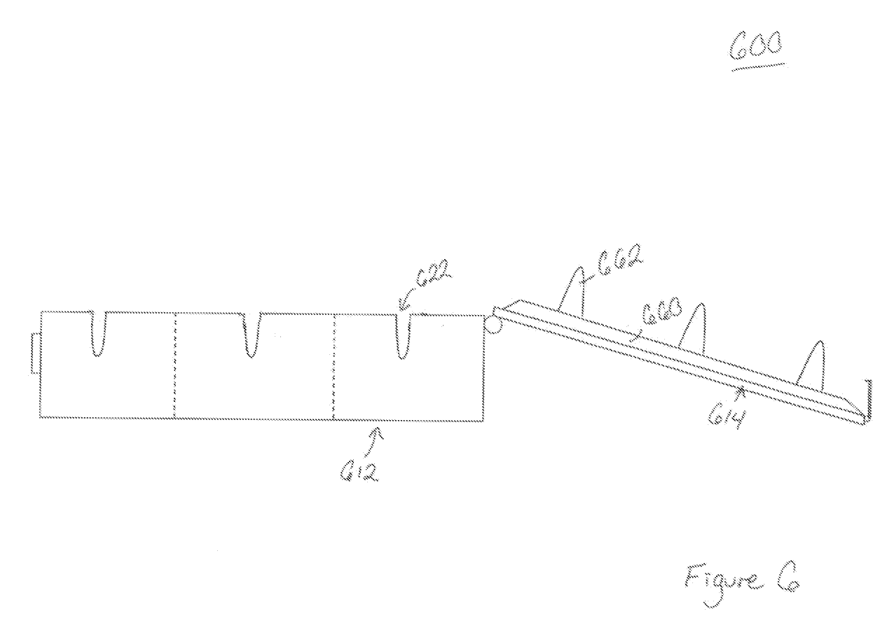

FIG. 6 depicts a side view of a system for preparing skewered food products in accordance with an embodiment of the present invention. In the embodiment depicted in FIG. 6, a sealing platform 660, having one or more sealing teeth 662 may be provided on an inside surface of the lid 614. In such an embodiment, the sealing teeth 662 may be aligned along the inner surface of the lid 614, such that when the lid 614 is closed, the sealing teeth 662 align with each of the skewer passageways 622 in the tray 612. When such an optional feature is utilized, is may entirely seal off one food section from any adjacent food section. As such, if combined with other optional features of certain embodiments of the present invention, such as the marinade portals described supra, each food portion could marinate in a different marinade without the different marinades mixing through any of the skewer passageways 622. If such an embodiment were utilized, however, a user may be able to remove the sealing platform 660 prior to skewering the food products.

Although various descriptions are provided herein for some of the embodiments of the present invention, a basic utilization of each of the embodiments is similar. In operation, a user may first put a food product in each of the food sections of an embodiment of the present invention. Optionally, the user may allow the food products to marinate through any of the means or optional features disclosed herein. Once the user is ready to skewer the food products, the lid of the skewering apparatus is closed, and a skewer is pushed through each of the skewer passageways until a sharp end of the skewer exists through the skewering apparatus opposite the end in which it entered. Once all the skewers have been pushed through each of the skewer passageways, the lid may be opened, and the user may remove each of the skewers by vertically lifting them out of the tray. As such, the skewering apparatus will have facilitated the preparation of skewered food products, and such skewered food products may subsequently be cooked, served and eaten in any manner suitable to those utilizing the systems described herein.

In further embodiments of the present invention, it should be appreciated that the skewering apparatus provided herein may be stackable with other similar apparatuses. For example, a user of the apparatus may be able to use two or more skewering apparatus and store them by stacking them on top of one another. In many of such embodiments, the skewering apparatus may be provided with a slight recessed portion of a top surface of the lid thereof sized to accept a slight protruding portion from a bottom surface of the tray, or vice versa (i.e., the tray comprises the recessed portion and the lid comprises the protruding portion). In one embodiment, the protruding portion comprises a handle on the top surface of the tray. As such, when such devices are stacked, there is a means for holding the skewering apparatuses in place, such that they do not slide off one another.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. An apparatus for skewering food products comprising:
a tray portion having at least two opposing sidewalls having skewer passageways extending therethrough, and a plurality of food sections provided therein, each food section defined by at least one length divider and at least one width divider, the width divider having a skewer passageway extending therethrough and aligning with the skewer passageways of the two opposing sidewalls; and
a lid portion, rotatably connected to the tray portion, the lid portion comprising a substantially flat inner surface for covering the food sections of the tray portion in a closed position.

2. The apparatus of claim 1, further comprising:
a locking mechanism on an outer surface of the lid portion for mating with a latch portion on an outside surface of the tray portion.

3. The apparatus of claim 1, wherein the apparatus comprises between about one to about eleven length dividers, and between about one to about eleven width dividers.

4. The apparatus of claim 3, wherein the apparatus comprises three length dividers and five width dividers.

5. The apparatus of claim 1, wherein the tray portion comprises a handle on a top surface thereof.

6. The apparatus of claim 1, wherein each of the at least one width divider is a moveable divider tab, capable of fitting into a guide rail system within the tray.

7. The apparatus of claim 1, wherein the lid portion further comprises a plurality of marinade portals, whereby in a closed position, the marinade portals align over a center of each food section.

8. The apparatus of claim 7, further comprising a plurality of sealing panels positioned over the outer sidewalls of the tray portion, for temporarily sealing the skewer passageways therethrough.

9. The apparatus of claim 1, further comprising a recessed portion on one of either the top surface of the lid or the bottom surface of the tray, and a protruding portion on the other of the either the top surface of the lid or the bottom surface of the tray, such that the general shape of the recessed portion matches the general shape of the protruding portion.

10. A system for skewering food products comprising:
a skewering apparatus comprising:
a tray portion comprising:
at least two opposing sidewalls having skewer passageways extending therethrough;
a plurality of food sections provided therein, each food section defined by at least one length divider and at least one width divider, the width divider having a skewer passageway extending therethrough and aligning with the skewer passageways of the two opposing sidewalls; and
a latch portion on an outside surface thereof; and
a lid portion, rotatably connected to the tray portion, the lid portion comprising:
a substantially flat inner surface for covering the food sections of the tray portion in a closed position; and
a locking mechanism on an outer surface of the lid portion for mating with a latch portion on an outside surface of the tray portion; and
a plurality of skewers for fitting into the skewer passageways of the tray portion, and extending the entire length thereof.

11. The apparatus of claim 10, wherein the apparatus comprises between about one to about eleven length dividers, and between about one to about eleven width dividers.

12. The apparatus of claim 11, wherein the apparatus comprises three length dividers and five width dividers.

13. The apparatus of claim 10, wherein the tray portion comprises a handle on a top surface thereof.

14. The apparatus of claim 10, wherein each of the at least one width divider is a moveable divider tab, capable of fitting into a guide rail system within the tray.

15. The apparatus of claim 10, wherein the lid portion further comprises a plurality of marinade portals, whereby in a closed position, the marinade portals align over a center of each food section.

16. The apparatus of claim 15, further comprising a plurality of sealing panels positioned over the outer sidewalls of the tray portion, for temporarily sealing the skewer passageways therethrough.

17. The apparatus of claim 10, further comprising a recessed portion on one of either the top surface of the lid or the bottom surface of the tray, and a protruding portion on the other of the either the top surface of the lid or the bottom surface of the tray, such that the general shape of the recessed portion matches the general shape of the protruding portion.

18. A method of skewering food on a skewer comprising:
providing a skewering apparatus comprising:
a tray portion comprising:
at least two opposing sidewalls having skewer passageways extending therethrough;
a plurality of food sections provided therein, each food section defined by at least one length divider and at least one width divider, the width divider having a skewer passageway extending therethrough and aligning with the skewer passageways of the two opposing sidewalls; and
a latch portion on an outside surface thereof; and
a lid portion, rotatably connected to the tray portion, the lid portion comprising:
a substantially flat inner surface for covering the food sections of the tray portion in a closed position; and
a locking mechanism on an outer surface of the lid portion for mating with a latch portion on an outside surface of the tray portion;
providing a plurality of skewers;
placing a food product in each of the plurality of food sections within the tray;
closing the lid;
inserting a skewer into each of the skewer passageways on one of the sidewalls of the tray portion;
pushing the skewer through each of the skewer passageways of the width dividers aligning with the skewer passageways of the sidewall, passing through the food in the food portion defined by such width dividers, until a tip of the skewer exists the skewering apparatus via the skewer passageway on the opposing sidewall;
opening the lid; and
removing each of the skewers by lifting vertically thereon.

19. The method of claim 18, further comprising:
engaging the locking mechanism to securely close the skewering apparatus prior to inserting the skewers.

20. The method of claim 18, further comprising:
filling each food portion with a marinade prior to inserting the skewers.
